(19) United States
(12) Patent Application Publication
(10) Pub. No.: US 2020/0145645 A1
(43) Pub. Date: May 7, 2020

(54) ARTICLE OF FURNITURE WITH STEREOSCOPIC DISPLAY DEVICE

(71) Applicant: CheRay Co. Ltd., Hsinchu City (TW)

(72) Inventors: CHUN-HSIANG YANG, Hsinchu City (TW); YI-PAI HUANG, Hsinchu City (TW); CHIH-HUNG TING, New Taipei City (TW); KAI-CHIEH CHANG, Kaohsiung City (TW); JUI-YI WU, Miaoli County (TW)

(21) Appl. No.: 16/178,545

(22) Filed: Nov. 1, 2018

(51) Int. Cl. H04N 13/305; A47B 97/00; A47B 21/04

(52) U.S. Cl. CPC H04N 13/305; A47B 97/00; A47B 21/04; A47B 2200/04; A47B 97/001; A47B 2200/0001; H04N 2213/001

(57) ABSTRACT

An article of furniture with a stereoscopic display device includes a furniture device and a stereoscopic display device. The furniture device includes a main body. The main body has an accommodating slot. The stereoscopic display device is disposed in the accommodating slot. The stereoscopic display device includes a flat panel display, a lens array layer and a microstructure layer. The lens array layer is disposed on a display surface of the flat panel display. The lens array layer is configured to adjust light field. The microstructure layer is disposed on the lens array layer. The microstructure layer is configured to modulate a direction of light. The stereoscopic display device is configured to display a stereo image floating in mid-air. Accordingly, a user can naturally see the stereo image floating in mid-air at an oblique viewing angle.

### FIELD OF THE DISCLOSURE

The present disclosure relates to an article of furniture, and more particularly to an article of furniture with a stereoscopic display device.

### BACKGROUND OF THE DISCLOSURE

Conventional stereoscopic display devices can display stereo images. However, the conventional stereoscopic display devices mainly employ the binocular vision imaging technology. For these kinds of display devices, a user has to view a stereo image at a frontal viewing angle directly facing the image, and cannot view the stereo image at other viewing angles (i.e. an oblique viewing angle). In certain situations where the stereoscopic display devices are placed horizontally, the user will naturally be staring at the image from an oblique angle, which prevents him from seeing a stereo (i.e., 3D) image as per the conventional technology. Moreover, the conventional stereoscopic display devices provide the user with visual stimuli in only one direction, i.e., either with the image projecting out or sinking in. Therefore, the conventional stereoscopic display devices cannot provide a vivid sensation that the image is escaping from the confines of a plane of the display surface and floating in mid-air. In addition, conventional articles of furniture, such as tables, do not have any stereo image display function.

In this regard, the present disclosure provides an article of furniture with a stereoscopic display device to overcome the aforementioned drawbacks.

### SUMMARY OF THE DISCLOSURE

The main object of the present disclosure is to provide an article of furniture with a stereoscopic display device that enables a user to naturally see a stereo image floating in mid-air at an oblique viewing angle.

In one aspect, the present disclosure provides an article of furniture with a stereoscopic display device which includes a furniture device and a stereoscopic display device. The furniture device includes a main body. The main body has an accommodating slot. The stereoscopic display device is disposed in the accommodating slot of the furniture device. The stereoscopic display device includes a flat panel display, a lens array layer and a microstructure layer. The flat panel display has a display surface. The lens array layer is disposed on the display surface of the flat panel display. The lens array layer includes a plurality of lenses. The lens array layer is configured to adjust light field. The microstructure layer is disposed on the lens array layer. The microstructure layer includes a plurality of microstructures. The microstructure layer is configured to modulate a direction of light. The stereoscopic display device is configured to display a stereo image that is floating in mid-air.

In one aspect, the present disclosure provides an article of furniture with a stereoscopic display device which includes a furniture device and a stereoscopic display device. The furniture device includes a main body. The stereoscopic display device is disposed on the main body of the furniture device. The stereoscopic display device includes a flat panel display, a lens array layer and a microstructure layer. The flat panel display has a display surface. The lens array layer is disposed on the display surface of the flat panel display. The lens array layer includes a plurality of lenses. The lens array layer is configured to adjust light field. The microstructure layer is disposed on the lens array layer. The microstructure layer includes a plurality of microstructures. The microstructure layer is configured to modulate a direction of light. The stereoscopic display device is configured to display a stereo image that is floating in mid-air.

In conclusion, the advantage of the present disclosure is that since a stereoscopic display device is integrated into an article of furniture, the article of furniture not only has its own function, but also has a stereo image display function. The stereoscopic display device of the present disclosure changes a frontal viewing angle of a conventional naked-eye 3D stereoscopic display device into an oblique viewing angle, and enables a user to see a stereo image at the oblique viewing angle. Moreover, the stereo image is displayed above or in front of the stereoscopic display device so as to generate an effect that the stereo image is floating in mid-air.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a perspective view showing an article of furniture with a stereoscopic display device according to a first embodiment of the present disclosure.

FIG. 2 is a cross-sectional view showing the partial configuration of the article of furniture with the stereoscopic display device according to the first embodiment of the present disclosure.

FIG. 3 is a schematic view showing a single lens which is focusing light in the stereoscopic display device according to the first embodiment of the present disclosure.

FIG. 4 is a perspective view showing an article of furniture with a stereoscopic display device according to a second embodiment of the present disclosure.

FIG. 5 is a perspective view showing an article of furniture with a stereoscopic display device according to a third embodiment of the present disclosure.

FIG. 6 is a perspective view showing an article of furniture with a stereoscopic display device according to a fourth embodiment of the present disclosure.

FIG. 7 is a perspective view showing an article of furniture with a stereoscopic display device according to a fifth embodiment of the present disclosure.

FIG. 8 is a perspective view showing an article of furniture with a stereoscopic display device according to a sixth embodiment of the present disclosure.

FIG. 9 is a perspective view showing an article of furniture with a stereoscopic display device according to a seventh embodiment of the present disclosure.

FIG. 10 is a perspective view showing an article of furniture with a stereoscopic display device according to an eighth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

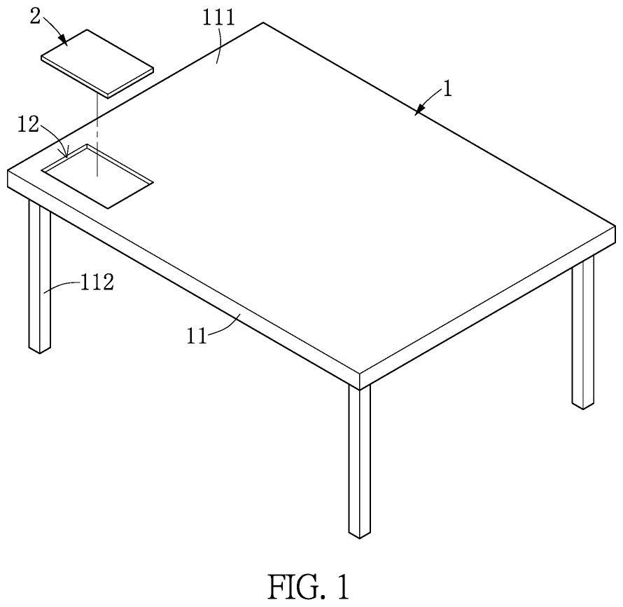

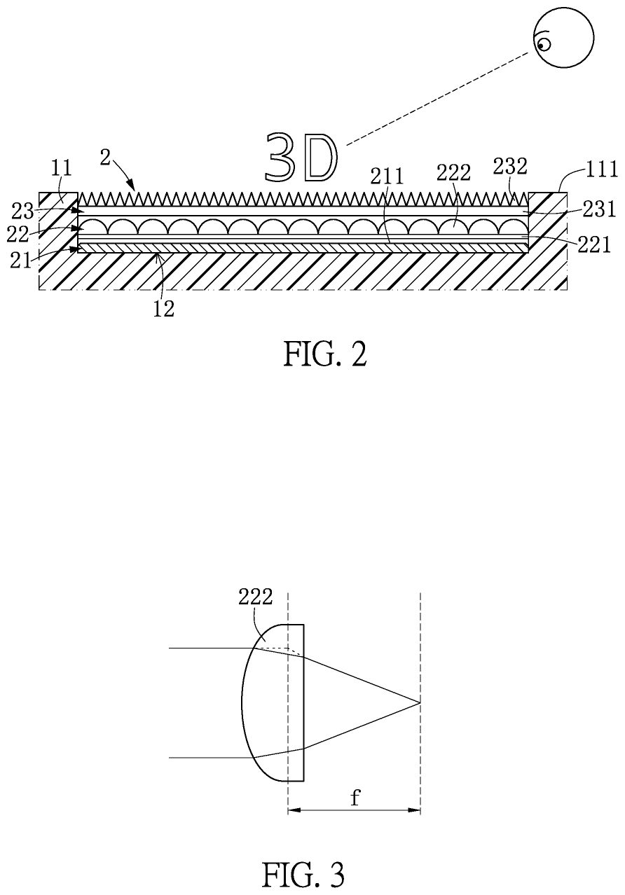

Referring to FIG. 1 and FIG. 2, the present disclosure provides an article of furniture with a stereoscopic display device which includes a furniture device 1 and a stereoscopic display device 2. The furniture device 1 may be a table, a display cabinet, a storage cabinet, a partition screen, a display platform, a ceiling, a floor, a wall or a partition. The furniture device 1 of the present embodiment is a table. The furniture device 1 includes a main body 11. The main body 11 may include components such as a table plate 111 and four table legs 112. The structure of the furniture device 1 is well known to the skilled artisan, and need not be reiterated herein. The table may be, but is not limited to, a living room table, a dining table, a desk or a console table.

The stereoscopic display device 2 is disposed on the furniture device 1. More specifically, the main body 11 of the furniture device 1 has an accommodating slot 12. In the present embodiment, the accommodating slot 12 is located at a top surface of the table plate 111 of the main body 11. The stereoscopic display device 2 is disposed in the accommodating slot 12, and a surface of the stereoscopic display device 2 is exposed outside the main body 11. Preferably, the surface of the stereoscopic display device 2 exposed outside the main body 11 is flush with (or is aligned with) the main body 11. That is, a top surface of the stereoscopic display device 2 is flush with the main body 11, but the present disclosure is not limited thereto. For example, the surface of the stereoscopic display device 2 exposed outside the main body 11 may protrude from the main body 11 or may be recessed in the main body 11. Moreover, two opposite sides of the stereoscopic display device 2 respectively abut against two opposite inner walls of the accommodating slot 12, such that the stereoscopic display device 2 can be firmly disposed in the accommodating slot 12.

The stereoscopic display device 2 includes a flat panel display 21, a lens array layer 22 and a microstructure layer 23. The flat panel display 21, the lens array layer 22, and the microstructure layer 23 are stacked sequentially from bottom to top in a three-layer structure. The flat panel display 21 has a display surface 211. The lens array layer 22 is disposed on the display surface 211 of the flat panel display 21, and the microstructure layer 23 is disposed on the lens array layer 22. The lens array layer 22 is preferably, but not limited to, in contact with the display surface 211 of the flat panel display 21. The microstructure layer 23 is preferably, but not limited to, in contact with the lens array layer 22. The stereoscopic display device 2 includes the three-layer structure. The flat panel display 21 is configured to emit light which is an integral image. The lens array layer 22 is configured to converge the light (reconstruct the integral image) so as to generate a stereo image that is floating in mid-air. The microstructure layer 23 is configured to deflect the light to an oblique angle. Accordingly, a user can see the stereo image at an oblique viewing angle which meets an ergonomic viewing angle.

The flat panel display 21 is disposed at the first layer (bottom layer) of the three-layer structure, and is configured to display an image based on an integral photography technology. The image displayed by the display surface 211 of the flat panel display 21 is redrawn based on an algorithm and the specification of the flat panel display 21. The algorithm requires no image inversion process and requires only depth information for calculation. The algorithm has steps including defining coordinates, obtaining depth information, integral image ray tracing, and reconstructing integral image. The flat panel display 21 includes an image algorithm unit including an image algorithm. The image used in the flat panel display 21 is calculated by the image algorithm. This calculation is matched to the configuration of the lens array layer 22, which predicts the various possible paths of the light, thereby calculating the relative position of the image. The image algorithm is well known to the skilled artisan, and need not be reiterated herein.

The lens array layer 22 is disposed at the second layer (middle layer) of the three-layer structure, and is configured to adjust light field. Lenses 222 (i.e. condenser lenses) of the lens array layer 22 are configured to modulate directions of lights of a 3D object, thereby allowing a user to see a stereo image at different viewing angles and to experience a stereoscopic visual effect with depth. Different lenses 222 assign different angular information to each point of the 3D object, and the lights from different lenses 222 converge into a point with depth information in mid-air. That is, for each point of the 3D object, the lights from different angles are assigned to different pixels of the lenses 222. The curvatures of the lenses 222 are determined by the materials thereof, and the curvatures of the lenses 222 as well as the combination of the lenses 222 and the flat panel display 21 determine the height, the range of viewing angle, and the clarity of the stereo image.

In the present embodiment, the lens array layer 22 is made of a material with good optical characteristics, which includes, but is not limited to, polymethylmethacrylate (PPMA), polycarbonate (PC), polyethylene (PE), glass or other light-transmissive materials. More specifically, the lens array layer 22 includes a plurality of lenses 222 and a base portion 221. The lenses 222 are respectively disposed on a surface of the base portion 221. That is, the lenses 222 are respectively disposed on the surface of the base portion 221 away from the flat panel display 21. It should be noted that the arrangement and structure of the lens array layer 22 is not limited to the features described above. The lenses 222 have focusing function. The curvatures and the materials of the lenses 222 as well as the combination of the lenses 222 and the flat panel display 21 determine the height, the range of viewing angle, and the clarity of the stereo image.

The microstructure layer 23 is disposed at the third layer (top layer) of the three-layer structure, and is configured to modulate a direction of light emitted from the flat panel display 21 and passing through the lens array layer 22. The microstructure layer 23 of the present embodiment includes a plurality of triangular-shaped microstructures 232 that can deflect the light to an oblique angle with respect to a frontal angle, so that a user can see the stereo image naturally at an oblique viewing angle, and need not see the stereo image at a frontal viewing angle.

In the present embodiment, the microstructure layer 23 is made of a material which includes, but is not limited to, polyester (PET), polypropylene (PP) or polycarbonate (PC). More specifically, the microstructure layer 23 includes a plurality of microstructures 232 and a base material 231. The microstructures 232 are respectively disposed on a surface of the base material 231. That is, the microstructures 232 are respectively disposed on the surface of the base material 231 away from the lens array layer 22. The microstructures 232 of the present embodiment are all triangular-shaped, such as isosceles triangle-shaped or right triangle-shaped. It should be noted that the arrangement and structure of the microstructure layer 23 is not limited to the features described above. Moreover, the stereoscopic display device 2 may further include a transparent plate (not shown) disposed on the microstructure layer 23 to provide a protective effect.

By virtue of the three-layer structure described above, light emitted from the flat panel display 21 can pass through the lens array layer 22 to converge into a 3D stereo image that is floating in mid-air. The microstructure layer 23 can further deflect the light to an oblique angle with respect to a frontal angle, so that a user can see the stereo image naturally at an oblique viewing angle which meets an ergonomic viewing angle.

The micro-structures of the lens array layer 22 are the lenses 222 with focusing function. The specification of each lens 222 will determine the lens focusing ability according to the refractive index n value of the material. The refractive index n value of the material ranges from 1.3 to 3.0. More specifically, the transmittance of the material is greater than or equal to 70%, and the reflectance of the material is less than or equal to 25%. Each lens 222 transmits light having a wavelength ranging from 300 nm to 1100 nm. The focal length f of a single lens 222 is shown in FIG. 3. Each lens 222 conforms to the Lensmaker's equation: 1/f=(n−1)(1/R1+1/R2), in which R1 and R2 are respective curvature radiuses of two opposite surfaces of the lens, f is a focal length of the lens, and n is a refractive index of the lens.

Accordingly, the present embodiment provides a stereoscopic display device 2 that enables a user to see a stereo image at an oblique viewing angle. The stereoscopic display device 2 is integrated into the furniture device 1 (i.e. a table) to enable the article of furniture to have a stereo image display function.

### Second Embodiment

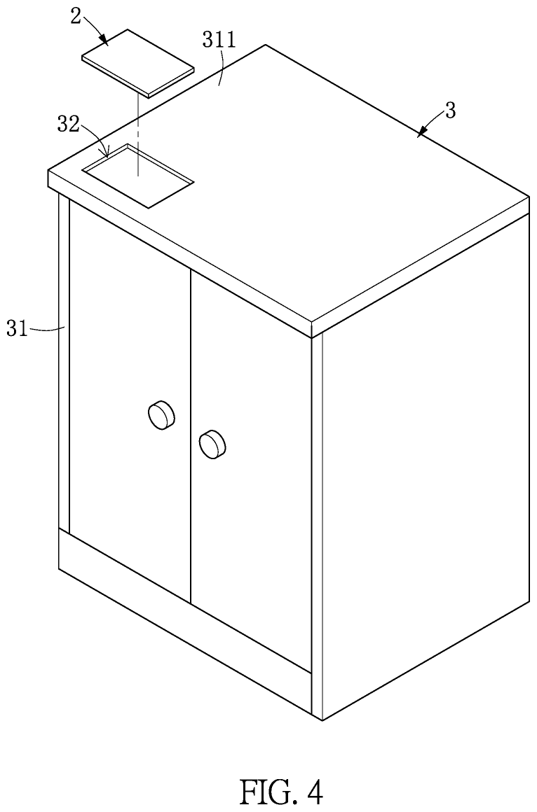

Referring to FIG. 4, the article of furniture includes a furniture device 3 and a stereoscopic display device 2. The furniture device 3 of the present embodiment is a display cabinet or a storage cabinet. The furniture device 3 includes a main body 31. The main body 31 may include components such as a cabinet body 311. The structure of the furniture device 3 is well known to the skilled artisan, and need not be reiterated herein.

The stereoscopic display device 2 is disposed on the furniture device 3. More specifically, the cabinet body 311 of the main body 31 of the furniture device 3 has an accommodating slot 32. In the present embodiment, the accommodating slot 32 is located at a top surface of the cabinet body 311 of the main body 31. The stereoscopic display device 2 is disposed in the accommodating slot 32, and a surface of the stereoscopic display device 2 is exposed outside the main body 31. Preferably, the surface of the stereoscopic display device 2 exposed outside the main body 31 is flush with (or is aligned with) the main body 31, but the present disclosure is not limited thereto. The stereoscopic display device 2 includes a flat panel display 21, a lens array layer 22 and a microstructure layer 23 as shown in FIG. 2. The configuration and function of the stereoscopic display device 2 of the present embodiment are the same as those of the first embodiment, and will not be reiterated herein. The article of furniture of the present embodiment includes the stereoscopic display device 2 that enables a user to see a stereo image at an oblique viewing angle. The stereoscopic display device 2 is integrated into the furniture device 3 (i.e. a display cabinet or a storage cabinet) to enable the article of furniture to have a stereo image display function.

### Third Embodiment

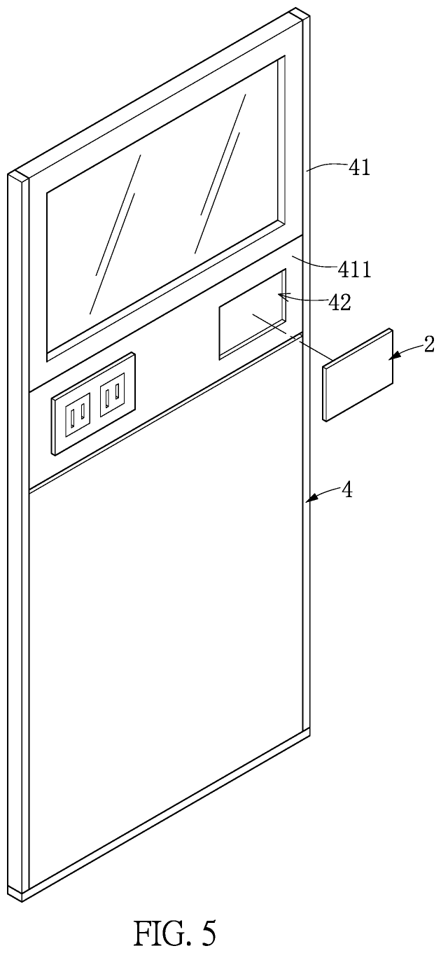

Referring to FIG. 5, the article of furniture includes a furniture device 4 and a stereoscopic display device 2. The furniture device 4 of the present embodiment is a partition screen. The furniture device 4 includes a main body 41. The main body 41 may include components such as a plate body 411. The structure of the furniture device 4 is well known to the skilled artisan, and need not be reiterated herein.

The stereoscopic display device 2 is disposed on the furniture device 4. More specifically, the plate body 411 of the main body 41 of the furniture device 4 has an accommodating slot 42. In the present embodiment, the accommodating slot 42 is located at a front side of the plate body 411 of the main body 41. The stereoscopic display device 2 is disposed in the accommodating slot 42, and a surface of the stereoscopic display device 2 is exposed outside the main body 41. Preferably, the surface of the stereoscopic display device 2 exposed outside the main body 41 is flush with (or is aligned with) the main body 41, but the present disclosure is not limited thereto. The stereoscopic display device 2 includes a flat panel display 21, a lens array layer 22 and a microstructure layer 23 as shown in FIG. 2. The configuration and function of the stereoscopic display device 2 of the present embodiment are the same as those of the first embodiment, and will not be reiterated herein. The article of furniture of the present embodiment includes the stereoscopic display device 2 that enables a user to see a stereo image at an oblique viewing angle. The stereoscopic display device 2 is integrated into the furniture device 4 (i.e. a partition screen) to enable the article of furniture to have a stereo image display function.

### Fourth Embodiment

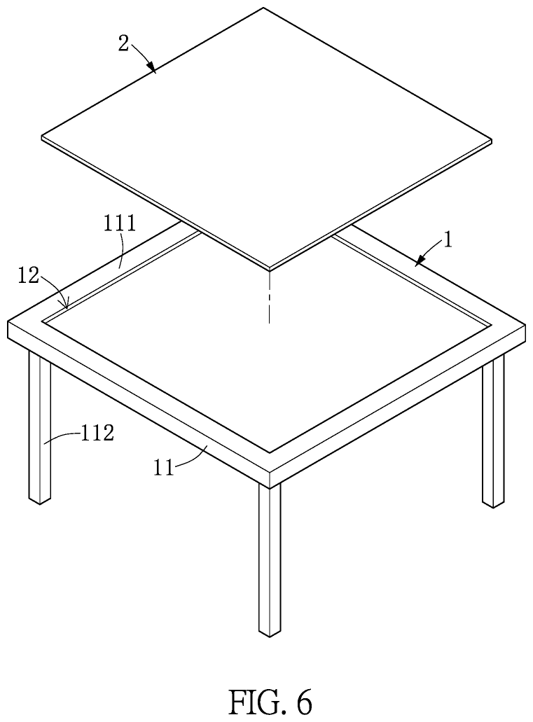

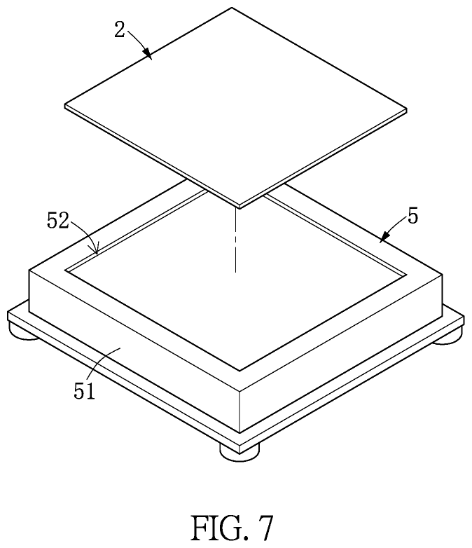

Referring to FIG. 6, the present embodiment is substantially the same as the first embodiment. The article of furniture includes a furniture device 1 and a stereoscopic display device 2. The furniture device 1 of the present embodiment is a table. The furniture device 1 includes a main body 11, the main body 11 has an accommodating slot 12, and the stereoscopic display device 2 is disposed in the accommodating slot 12 of the furniture device 1. The size of the stereoscopic display device 2 of the present embodiment is greater than that of the first embodiment. More specifically, the size of the stereoscopic display device 2 of the present embodiment is close to the size of the table plate 111 of the main body 11, so that the stereoscopic display device 2 can occupy substantially the entire top surface of the table plate 111 when being disposed on the main body 11 of the furniture device 1.

### Fifth Embodiment

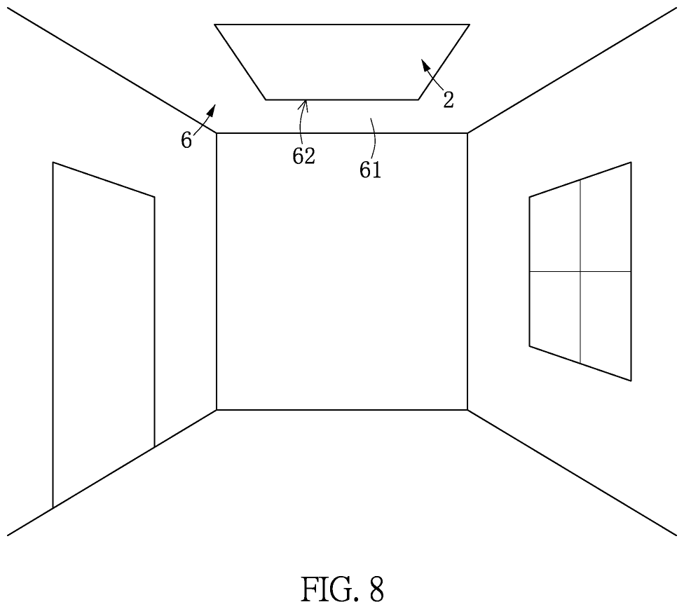

Referring to FIG. 7, the article of furniture includes a furniture device 5 and a stereoscopic display device 2. The furniture device 5 of the present embodiment is a display platform. The furniture device 5 includes a main body 51. The structure of the furniture device 5 is well known to the skilled artisan, and need not be reiterated herein.

The stereoscopic display device 2 is disposed on the furniture device 5. More specifically, the main body 51 of the furniture device 5 has an accommodating slot 52. In the present embodiment, the accommodating slot 52 is located at a top surface of the main body 51. The stereoscopic display device 2 is disposed in the accommodating slot 52, and a surface of the stereoscopic display device 2 is exposed outside the main body 51. The configuration and function of the stereoscopic display device 2 of the present embodiment are the same as those of the first embodiment, and will not be reiterated herein. The article of furniture of the present embodiment includes the stereoscopic display device 2 that enables a user to see a stereo image at an oblique viewing angle. The stereoscopic display device 2 is integrated into the furniture device 5 (i.e. a display platform) to enable the article of furniture to have a stereo image display function.

### Sixth Embodiment

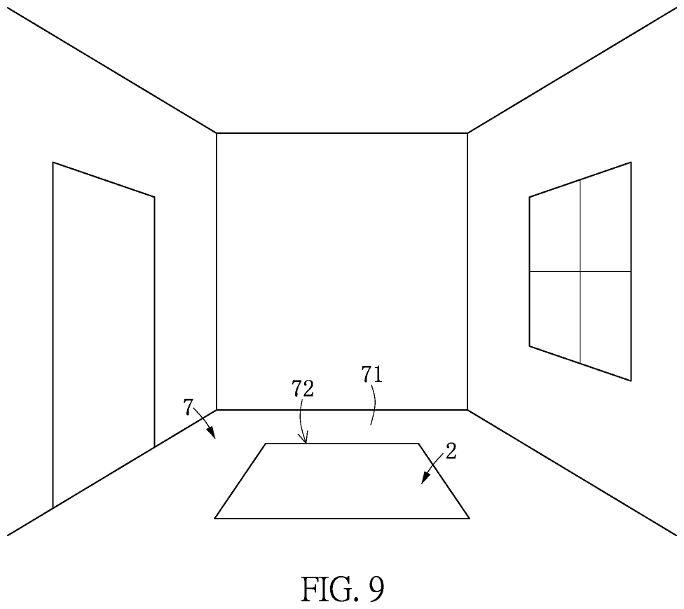

Referring to FIG. 8, the article of furniture includes a furniture device 6 and a stereoscopic display device 2. The furniture device 6 of the present embodiment is a ceiling. The furniture device 6 includes a main body 61. The structure of the furniture device 6 is well known to the skilled artisan, and need not be reiterated herein.

The stereoscopic display device 2 is disposed on the furniture device 6. More specifically, the main body 61 of the furniture device 6 has an accommodating slot 62. In the present embodiment, the accommodating slot 62 is located at a bottom surface of the main body 61. The stereoscopic display device 2 is disposed in the accommodating slot 62, and a surface of the stereoscopic display device 2 is exposed outside the main body 61. The configuration and function of the stereoscopic display device 2 of the present embodiment are the same as those of the first embodiment, and will not be reiterated herein. The article of furniture of the present embodiment includes the stereoscopic display device 2 that enables a user to see a stereo image at an oblique viewing angle. The stereoscopic display device 2 is integrated into the furniture device 6 (i.e. a ceiling) to enable the article of furniture to have a stereo image display function.

### Seventh Embodiment

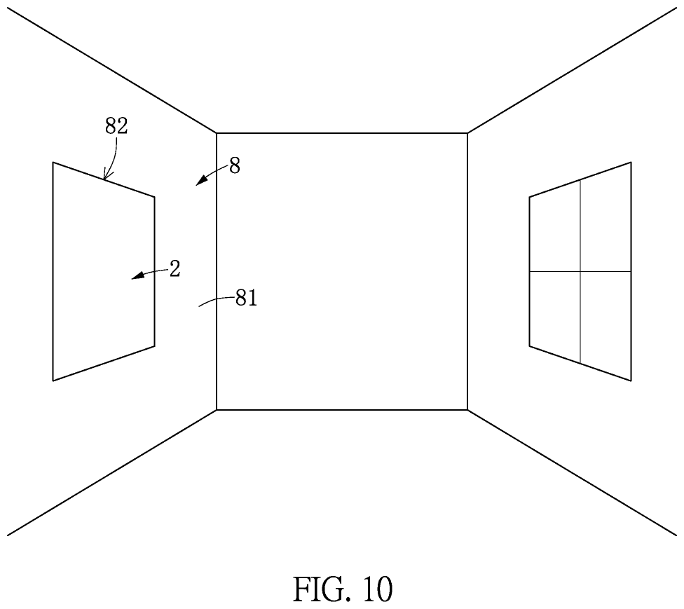

Referring to FIG. 9, the article of furniture includes a furniture device 7 and a stereoscopic display device 2. The furniture device 7 of the present embodiment is a floor. The furniture device 7 includes a main body 71. The structure of the furniture device 7 is well known to the skilled artisan, and need not be reiterated herein.

The stereoscopic display device 2 is disposed on the furniture device 7. More specifically, the main body 71 of the furniture device 7 has an accommodating slot 72. In the present embodiment, the accommodating slot 72 is located at a top surface of the main body 71. The stereoscopic display device 2 is disposed in the accommodating slot 72, and a surface of the stereoscopic display device 2 is exposed outside the main body 71. The configuration and function of the stereoscopic display device 2 of the present embodiment are the same as those of the first embodiment, and will not be reiterated herein. The article of furniture of the present embodiment includes the stereoscopic display device 2 that enables a user to see a stereo image at an oblique viewing angle. The stereoscopic display device 2 is integrated into the furniture device 7 (i.e. a floor) to enable the article of furniture to have a stereo image display function.

### Eighth Embodiment

Referring to FIG. 10, the article of furniture includes a furniture device 8 and a stereoscopic display device 2. The furniture device 8 of the present embodiment is a wall (or a partition). The furniture device 8 includes a main body 81. The structure of the furniture device 8 is well known to the skilled artisan, and need not be reiterated herein.

The stereoscopic display device 2 is disposed on the furniture device 8. More specifically, the main body 81 of the furniture device 8 has an accommodating slot 82. In the present embodiment, the accommodating slot 82 is located at a front side of the main body 81. The stereoscopic display device 2 is disposed in the accommodating slot 82, and a surface of the stereoscopic display device 2 is exposed outside the main body 81. The configuration and function of the stereoscopic display device 2 of the present embodiment are the same as those of the first embodiment, and will not be reiterated herein. The article of furniture of the present embodiment includes the stereoscopic display device 2 that enables a user to see a stereo image at an oblique viewing angle. The stereoscopic display device 2 is integrated into the furniture device 8 (i.e. a wall) to enable the article of furniture to have a stereo image display function.

In conclusion, the advantage of the present disclosure is that since a stereoscopic display device is integrated into an article of furniture, the article of furniture not only has its own function, but also has a stereo image display function. The stereoscopic display device of the present disclosure changes a frontal viewing angle of a conventional naked-eye 3D stereoscopic display device into an oblique viewing angle, and enables a user to see a stereo image at the oblique viewing angle. Moreover, the stereo image is displayed above or in front of the stereoscopic display device so as to generate an effect that the stereo image is floating in mid-air.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An article of furniture with a stereoscopic display device, comprising:
a furniture device including a main body; wherein the main body has an accommodating slot; and
a stereoscopic display device disposed in the accommodating slot of the furniture device;
wherein the stereoscopic display device includes a flat panel display, a lens array layer and a microstructure layer, the flat panel display has a display surface, the lens array layer is disposed on the display surface of the flat panel display, the lens array layer includes a plurality of lenses, the lens array layer is configured to adjust light field, the microstructure layer is disposed on the lens array layer, the microstructure layer includes a plurality of microstructures, the microstructure layer is configured to modulate a direction of light, and the stereoscopic display device is configured to display a stereo image that is floating in mid-air.

2. The article of furniture with the stereoscopic display device according to claim 1, wherein a surface of the stereoscopic display device exposed outside the main body is flush with the main body.

3. The article of furniture with the stereoscopic display device according to claim 1, wherein a surface of the stereoscopic display device exposed outside the main body protrudes from the main body or is recessed in the main body.

4. The article of furniture with the stereoscopic display device according to claim 1, wherein two opposite sides of the stereoscopic display device respectively abut against two opposite inner walls of the accommodating slot.

5. The article of furniture with the stereoscopic display device according to claim 1, wherein each lens conforms to the Lensmaker's equation: 1/f=(n−1)(1/R1+1/R2), wherein R1 and R2 are respective curvature radiuses of two opposite surfaces of the lens, f is a focal length of the lens, and n is a refractive index of the lens.

6. The article of furniture with the stereoscopic display device according to claim 1, wherein the accommodating slot is located at a top surface of the main body or is located at a front side of the main body.

7. The article of furniture with the stereoscopic display device according to claim 1, wherein the furniture device is a table, the main body includes a table plate and a plurality of table legs, and the accommodating slot is located at a top surface of the table plate.

8. The article of furniture with the stereoscopic display device according to claim 1, wherein the furniture device is a display cabinet or a storage cabinet, the main body includes a cabinet body, and the accommodating slot is located at a top surface of the cabinet body.

9. The article of furniture with the stereoscopic display device according to claim 1, wherein the furniture device is a partition screen, the main body includes a plate body, and the accommodating slot is located at a front side of the plate body.

10. The article of furniture with the stereoscopic display device according to claim 1, wherein the furniture device is a table, a display cabinet, a storage cabinet, a partition screen, a display platform, a ceiling, a floor, a wall or a partition.

11. An article of furniture with a stereoscopic display device, comprising:
a furniture device including a main body; and
a stereoscopic display device disposed on the main body of the furniture device;
wherein the stereoscopic display device includes a flat panel display, a lens array layer and a microstructure layer, the flat panel display has a display surface, the lens array layer is disposed on the display surface of the flat panel display, the lens array layer includes a plurality of lenses, the lens array layer is configured to adjust light field, the microstructure layer is disposed on the lens array layer, the microstructure layer includes a plurality of microstructures, the microstructure layer is configured to modulate a direction of light, and the stereoscopic display device is configured to display a stereo image that is floating in mid-air.

12. The article of furniture with the stereoscopic display device according to claim 11, wherein the furniture device is a table, a display cabinet, a storage cabinet, a partition screen, a display platform, a ceiling, a floor, a wall or a partition.
